(19) United States
(12) Patent Application Publication
(10) Pub. No.: US 2008/0291218 A1
(43) Pub. Date: Nov. 27, 2008

(54) System And Method For Generating Interactive Video Images

(75) Inventors: Fuzhong Sheng, Shenzhen (CN); Xiuxing Du, Shenzhen (CN); Yan Zhao, Shenzhen (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen (CN)

(21) Appl. No.: 12/176,447

(22) Filed: Jul. 21, 2008

Related U.S. Application Data
(63) Continuation of application No. PCT/CN2007/000214, filed on Jan. 19, 2007.

(30) Foreign Application Priority Data
Jan. 21, 2006 (CN) 200610033279.9

(51) Int. Cl. G09G 5/00; G06T 15/70

(52) U.S. Cl. 345/630; 345/473

(57) ABSTRACT

The present invention relates to video communication technology and discloses a system and method for generating animated video images. The present invention provides a system for generating animated video images, including a video image capture module, an animation capture module and an overlay module, for the purpose of overcoming the disadvantages of current video interaction system, such as poor video interaction experience and dull images. The present invention also provides a method for generating animated video images, comprising capturing video images, obtaining animation frames and overlaying the video images with the animation frames.

### CROSS-REFERENCE TO RELATED APPLICATIONS

This application is a continuation of International Application No. PCT/CN2007/000214, filed Jan. 19, 2007. This application claims the benefit of Chinese Application No. 200610033279.9, filed Jan. 21, 2006. The disclosures of the above applications are incorporated herein by reference.

### FIELD

The present disclosure relates to the video communication field, and particularly, to a system and method for generating interactive video images.

### BACKGROUND

The statements in this section merely provide background information related to the present disclosure and may not constitute prior art.

Instant Messaging (IM) is an internet based communication service providing mainly instant communication functions over networks. The IM service is fast and stable, has rich varieties of functions and occupies small amount of system resources, hence the IM service is widely adopted at present.

IM tools are also widely adopted currently among “netizens” as a kind of indispensable network tools for text interaction, audio interaction as well as video interaction. The present IM tools and other video interaction tools usually use normal video clips captured by cameras in the video interaction, that is, a receiving end of the video images receives the images directly captured by the cameras. However, a user usually has some objects around that interfere the eye sight and further affect the video interaction experience of the user. The simple video images are comparatively too dull to satisfy the customized demands of some users.

### SUMMARY

The objective of the present invention is to provide a system and method for generating interactive video images in order to solve the problems of unsatisfactory video interaction experience and dull images for users of the present video interactive systems. According to the technical scheme of the present invention, a user may choose an animation frame, overlay the chosen animation frame with a video image and output the overlaid video image at the transmitting end or receiving end, or combine the chosen animation frame with the video image output into an animation frame to be played at the transmitting end or receiving end. In this way a display window may show the animation frame and the video image at the same time to provide video image interaction and entertainment.

The embodiment of the present invention also provides a system for generating interactive video images. The system comprises a video image capture module, an animation capture module and an overlay module, wherein the video image capture module is adapted to capture video images and output the video images to the overlay module, the animation capture module is adapted to capture animation frames and output the animation frames to the overlay module, and the overlay module is adapted to overlay the video images from the video image capture module with the animation frames from the animation capture module.

The present invention further provides a method for generating interactive video images, comprising: capturing video images, obtaining animation frames and overlaying the video images with the animation frames.

By overlaying video images with animation frames, the system and method provided by the present invention for generating interactive video images enable a user to watch both animations and videos in one display window at the same time and add more pleasure into the video interaction. The animation frames may overlap and cover the images of the objects which interfere with the eyesight of the user and improve visual presentation of the video images aesthetically, and the user may choose the overlapping animation frames freely, which further increases the pleasure and the interactivity of the video interaction. In addition, by using the present invention, the original video images can be converted into images of animation format and made into an animation file with overlaying animation frames for the purpose of storage or applications such as being sent to the display utility of a chatting friend, such animation file can provide even richer visual effect than ever.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustrating the structure of the system provided by Embodiment 1 of the present invention for generating interactive video images;

FIG. 2 is a flow chart of the method provided by Embodiment 1 of the present invention for generating interactive video images;

FIG. 3 is a schematic illustrating the structure of the system provided by Embodiment 2 of the present invention for generating interactive video images;

FIG. 4 is a flow chart of the method provided by Embodiment 2 of the present invention for generating interactive video images;

FIG. 5 is a schematic illustrating an alternative structure of the system provided by Embodiment 2 of the present invention for generating interactive video images;

FIG. 6 is a schematic illustrating another alternative structure of the system provided by Embodiment 2 of the present invention for generating interactive video images;

FIG. 7 is a schematic illustrating an animation frame with transparent parts in the present invention;

FIG. 8 is a schematic illustrating yet another alternative structure of the system provided by Embodiment 2 of the present invention for generating interactive video images;

FIG. 9 is a schematic illustrating the structure of the system provided by Embodiment 3 of the present invention for generating interactive video images;

FIG. 10 is a flow chart of the method provided by Embodiment 3 of the present invention for generating interactive video images;

FIG. 11 is a schematic illustrating the method of combining a plurality of animation frames into one animation frame.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The present invention will be further described hereinafter with reference to accompanying drawings and embodiments.

The present invention provides a system and method for generating interactive video images so that a user may choose an animation frame to play over the display of the video images and thus get better interactivity and entertainment in the video image interaction.

### Embodiment 1

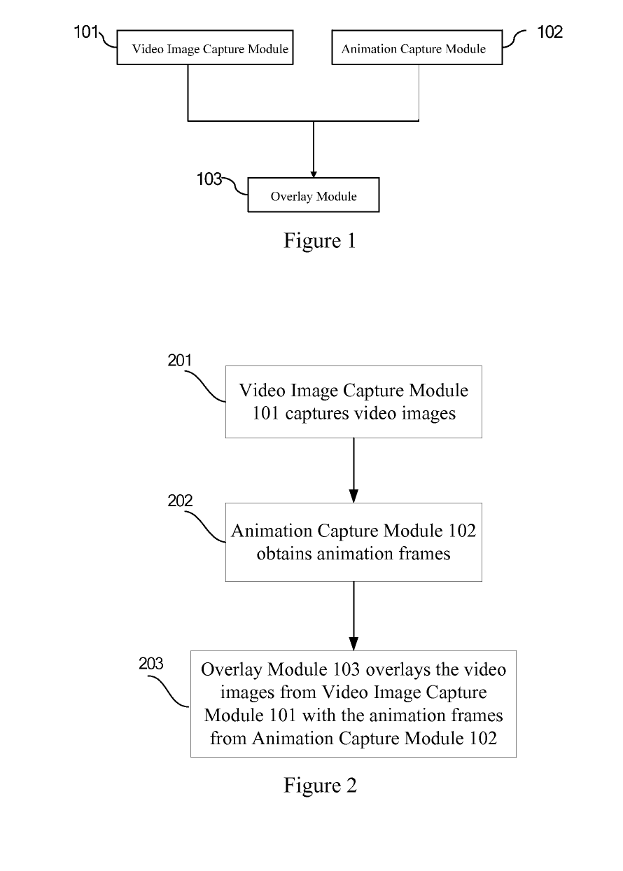

As shown in FIG. 1, this embodiment provides a system for generating interactive video images, including Video Image Capture Module 101, Animation Capture Module 102 and Overlay Module 103.

The output of Video Image Capture Module 101 and the output of Animation Capture Module 102 are exported to Overlay Module 103.

Video Image Capture Module 101 is adapted to capture video images and output the video images to Overlay Module 103. Animation Capture Module 102 is adapted to capture animation frames and output the animation frames to Overlay Module 103. The animation frames are standard animation frames prepared in advance and can be obtained from an animation library. The animation library can be set up in the transmitting end of the video interaction or in a server. Overlay Module 103 is adapted to overlay the video images from Video Image Capture Module 101 with the animation frames from Animation Capture Module 102.

As shown in FIG. 2, this embodiment also provides a method for generating interactive video images by overlaying video images with animation frames during video communications. The method comprises the steps as follows to achieve the objective of the present invention:

Step 201: Video Image Capture Module 101 captures video images.

Step 202: Animation Capture Module 102 captures animation frames from an animation library.

Step 203: Overlay Module 103 overlays the video images from Video Image Capture Module 102 with the animation frames from Animation Capture Module 101.

The invention will be further explained with reference to embodiments hereinafter.

### Embodiment 2

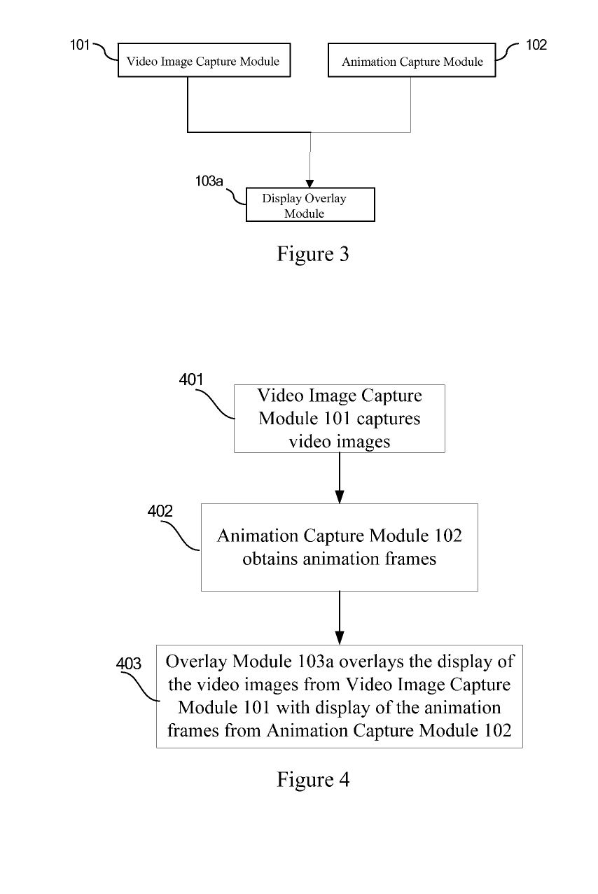

As shown in FIG. 3, this embodiment provides a system for generating interactive video images, including Video Image Capture Module 101, Animation Capture Module 102 and Display Overlay Module 103a.

The output of Video Image Capture Module 101 and the output of Animation Capture Module 102 are exported to Display Overlay Module 103a.

Video Image Capture Module 101 is adapted to capture video images and output the video images to Display Overlay Module 103a. Animation Capture Module 102 is adapted to capture animation frames and output the animation frames to Display Overlay Module 103a. Display Overlay Module 103a is adapted to overlay the display of the video images from Video Image Capture Module 101 with the display of the animation frames from Animation Capture Module 102.

As shown in FIG. 4, this embodiment also provides a method for generating interactive video images by overlaying video images with animation frames during video communications. The method comprises the steps as follows:

Step 401: Video Image Capture Module 101 captures the video images.

Video Image Capture Module 101 may capture the video images via a camera or from a previously saved video clip.

Furthermore, Video Image Capture Module 101 may convert the video images into static images. The format of the static images may be the single-frame video image format, the JPG format, the BMP format or any of other static image formats.

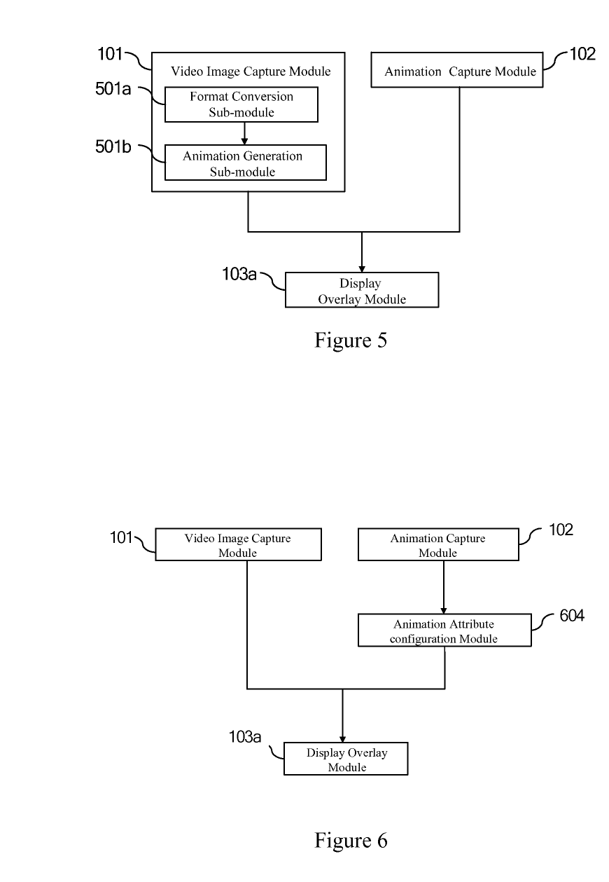

As shown in FIG. 5, Video Image Capture Module 101 in this embodiment may further comprises two sub-modules: Format Conversion Sub-module 501a and Animation Generation Sub-module 501b.

Format Conversion Sub-module 501a is adapted to convert the video images into pictures in a preset format and send the pictures in the preset format to Animation Generation Sub-module 501b. Animation Generation Sub-module 501b is adapted to convert the pictures in the preset format from Format Conversion Sub-module 501a into animation frames.

In this embodiment, video images in an animation format are obtained through the following two steps:

Step a): Format Conversion Sub-module 501a converts video images, e.g., the video images captured by a camera, into pictures in the preset format as the source video images. The preset format in this embodiment is the JPG format, however, standard picture formats such as the GIF and the BMP can also be adopted in practical applications.

Step b): Animation Generation Sub-module 501b converts the pictures in the preset format from Format Conversion Sub-module 501a into animation frames. The animation frames may be the frames of the SWF (Shockwave format) or the frames of the animated GIF or the frames of any other animation format.

In this embodiment, Video Image Capture Module 101 captures the video images via a camera.

Step 402: Animation Capture Module 102 captures the animation frames.

The animation frames may include standard animation from an animation library.

As shown in FIG. 6, an Animation Attribute Configuration Module 604 can be added into the system to configure a transparency attribute of every pixel in the animation frames from the Animation Capture Module 102 as well as the format, the layers and the window size of the animation frames so that the animation frames will fit the video images, and the Animation Attribute Configuration Module 604 further output the animation frames with the configured transparency attribute to Display Overlay Module 103a. After Step 402, Animation Attribute Configuration Module 604 configures the transparency attribute of the standard animation frames to produce animation frames with different transparency levels.

The animation frames consist of many pixels and Animation Attribute Configuration Module 604 configures the transparency attribute of every pixel in the animation. The transparency value, which shows the transparency level of a pixel, usually falls into a certain range, e.g., 0-255, or 0-100%, the lowest and the highest thresholds of the value indicate completely opaque (completely visible) and completely transparent (completely invisible) respectively, and the middle values indicate different levels of translucence.

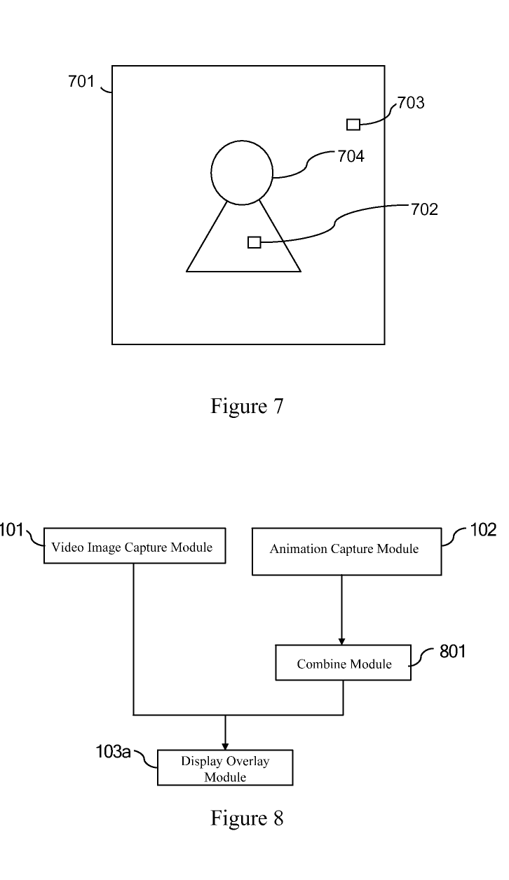

As shown in FIG. 7, Pixel 703 may be configured to be invisible, i.e., to have the highest transparency value, and Pixel 702 may be configured to be completely visible, i.e., to have the lowest transparency value. In the area of Animation 701, when the pixels in Article 704 are configured to be visible and the rest of the pixels are configured to be invisible, the animation will be shown in accordance with such transparency settings, i.e., all but Article 704 will be transparent.

As shown in FIG. 8, a Combine Module 801 may further be added into the system to enrich the visual effect of the video interaction. Combine Module 801 is adapted to combine a plurality of animation frames from Animation Capture Module 102 into a new animation frame to be output into Display Overlay Module 103a (or File Overlay Module 103b in Embodiment 3). The format of the animation frames to be combined may be the GIF, the Flash, the BMP or the JPG format and the format of the new combined animation frame may be the GIF or the Flash format. The new combined animation frame is played in the display window so that the user may enjoy animation with rich visual effects. In this embodiment, every animation frame is put into a subsidiary animation clip (DefineSprite) of the new animation and all subsidiary animation clips are shown on different layers in every frame of the new animation. The step of combining will be explained in detail in Embodiment 3.

A Flash player plug-in is required to support the playback of Flash files. The format of the animation file may be the Flash or the GIF or other animation or image formats.

In this embodiment, the system may further include a selection module adapted to enable the user to choose customized animation frames via a man-machine interface. The user may also configure the chosen animation frames, e.g., sets the playback time and transparency of the animation frames.

Step 403: Display Overlay Module 103a overlays the display of the video images from Video Image Capture Module 101 with the display of the animation frames from Animation Capture Module 102.

In this embodiment, the display window is divided into two layers: the video images are played on the lower layer and the animation frames are played on the upper layer. The display window may include even more layers in practical applications. The display of the animation frames or video images includes the contents played in the display window. Since the animation frames may have transparent parts, contents of the video images under the transparent parts will be seen and in this way the animation frames and the video images are combined visually. The user may watch the animation frames and the video images at the same time to enjoy the animation and video interaction experience between video interaction users.

A synthesized visual effect is achieved by playing the video images and one or multiple animation frames continuously in the display window. For example, the video images are played on the bottom layer of the display window while different animation frames are played on designated locations or in different layers of the display window at the same time.

### Embodiment 3

In Embodiment 2, the display of the animation frames is enabled to overlap the display of the video images in the display window by using Display Overlay Module 103a and the synthesized visual effect of overlaying video with animation is achieved with the interesting animated objects in the animation frames. In this embodiment, the contents of the animation frames and the contents of the video images can further be combined into an animation file and the animation file can be saved, played at the transmitting end or sent to the receiving end for playing.

As shown in FIG. 9, this embodiment comprises Video Image Capture Module 101, Animation Capture Module 102 and File Overlay Module 103b. The output of Video Image Capture Module 101 and the output of Animation Capture Module 102 are exported to File Overlay Module 103b.

Video Image Capture Module 101 is adapted to capture the video images and the output the video images to File Overlay Module 103b. Animation Capture Module 102 is adapted to capture animation frames and output the animation frames to File Overlay Module 103b. File Overlay Module 103b is adapted to combine the animation frames from Animation Capture Module 102 and the video images from Video Image Capture Module 101 into one file.

Video Image Capture Module 101 may capture the video images via a camera or from a previously saved video clip.

Furthermore, Video Image Capture Module 101 may convert the video images into static images. The format of the static images may be the single-frame video image format, the JPG format, the BMP format or any of other static image formats.

Video Image Capture Module 101 may further include the following two sub-modules:

Format Conversion Sub-module 501a is adapted to convert the video images, e.g., video images captured by a camera, into pictures in a preset format as the source video images and send the pictures in the preset format to Animation Generation Sub-module 501b.

Animation Generation Sub-module 501b is adapted to convert the pictures in the preset format from Format Conversion Sub-module 501a into animation frames.

The output of Format Conversion Sub-module 501a is sent to Animation Generation Sub-module 501b.

When Video Image Capture Module 101 comprises both Format Conversion Sub-module 501a and Animation Generation Sub-module 501b, File Overlay Module 103b is further adapted to combine the animation frames from Animation Capture Module 102 and the animation generated by Animation Generation Sub-module 501b by using the video images into one animation file to be played at the receiving end or at both the transmitting and the receiving ends.

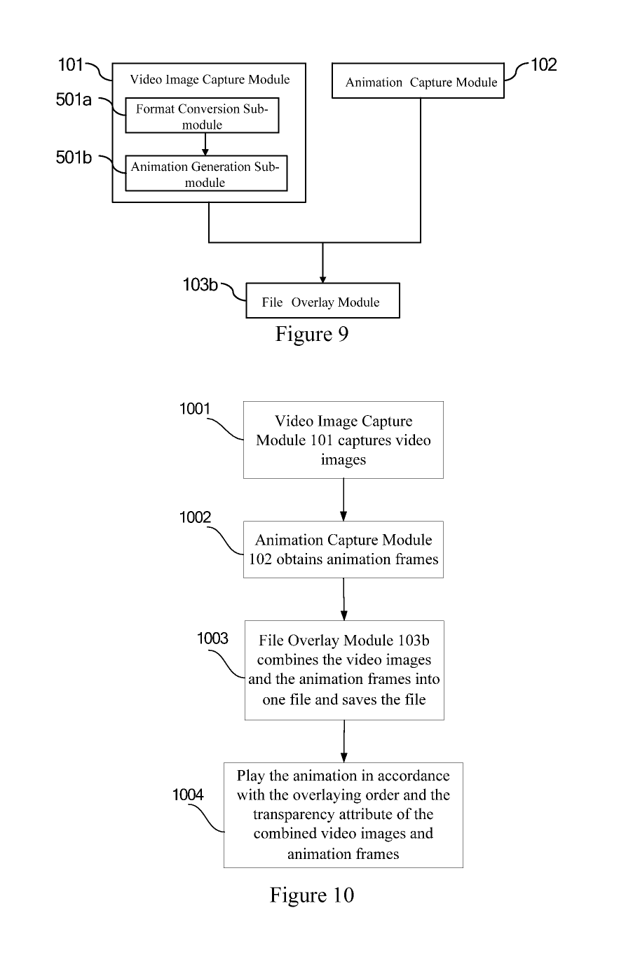

As shown in FIG. 10, the system of this embodiment is mainly adapted to perform the following steps:

Step 1001: Video Image Capture Module 101 captures the video images.

In this embodiment, the format of the video images is animation file format, and the video images of animation file format may be generated through the following two steps:

Step a): Format Conversion Sub-module 501a converts the video images captured by Video Image Capture Module 101, e.g., the video images captured by a camera, into pictures in a preset format as the source video images. The preset format in this embodiment is the JPG format, however, standard image formats such as the GIF and the BMP can also be adopted in practical applications.

Step b): Animation Generation Sub-module 501b converts the pictures in the preset format from Format Conversion Sub-module 501a into animation frames. The animation frames may be the frames of the SWF (Shockwave format) or the frames of the animated GIF or the frames of any other animation format.

Step 1002: Animation Capture Module 102 captures the animation frames.

This step is identical to Step 402 and will not be described further herein.

Similar to Embodiment 2, this embodiment may further comprises an animation attribute configuration module adapted to configure a transparency attribute of every pixel in the animation frames from the animation capture module and sends the animation frames with configured transparency attribute to File Overlay Module 103b. After Step 1002, the animation attribute configuration module configures the transparency attribute of the standard animation frames to produce animation frames with different transparency levels. The procedure employed is identical to the procedure adopted in Embodiment 2 and will not be described further herein.

Similar to Embodiment 2, this embodiment may further include a combine module in the system.

Step 1003: File Overlay Module 103b combines the animation generated by Animation Generation Sub-module 501b in Step 1001 and the animation frames obtained from Animation Capture Module 102 in Step 1002 into one animation file by different layers, and saves the animation file.

In this embodiment, the animation frames generated from the video images in Step 1001 is put in the bottom layer while the animation frames obtained in Step 1002 are put in upper layers and the layers are then merged into one animation. In practical applications, a number of animation frame layers can be merged. And the animation frames generated from the video images in Step 1001 may also be put in the upper layer while the animation frames obtained in Step 1002 are put in the bottom layer before layers are merged in practical application.

Step 1004: the display window displays the animation obtained in Step 1003 according to the layer order and the transparency attribute of each layer; the contents of an upper layer shall cover the contents of lower layers while transparent pixels in the upper layer are shown as invisible.

Display Overlay Module 103a in Embodiment 2 and File Overlay Module 103b in Embodiment 3 can be generally referred to as Overlay Module 103.

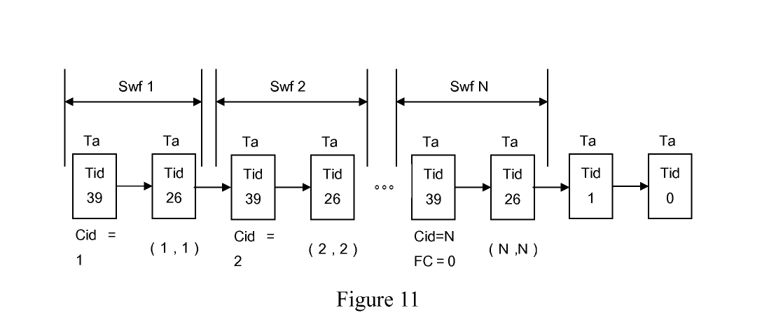

As shown in FIG. 11, the method of combining a plurality of animation frames into one new animation is described with reference to an example in which a plurality of Flash file are combined into one animation file. The method comprises the following steps:

Step 1: create a Swf prototype PrototypeSwf for N Flash files.

Step a): in PrototypeSwf, create two label blocks for each of the Flash files to be combined, namely DefineSprite (Tid=39) and PlaceObject2 (Tid=26). The CID of every DefineSprite label block is regarded as the order number of corresponding file in the combining procedure, for example, the CID of Flash file 1 is 1, the CID of Flash file N is N. Initially the frameCount of animation in every DefineSprite label block is 0. The 2-tuple information (Lid, Cid) of every PlaceObject2 label block is set to (i, i), wherein i indicates the ith Flash file and that the object with CID i shall be put on the ith layer.

Step b): add two additional label blocks at the tail of PrototypeSwf, namely ShowFrame (Tid=1) and End (Tid=0).

Step c): when the Flash player parses the ShowFrame label block, N 2-tuples will be shown in the display list, each of the 2-tuples indicates that an object with CID i shall be put on the ith layer. In this way, N Flash files are played at the same time, and the overlapping order of the N Flash files depends directly on the order of importing the N flash files, i.e., the contents of Flash file 1 is at the bottom and the contents of Flash file N is at the top.

Step 2: after configuring the Swf prototype, add the Flash files into corresponding subsidiary animation clips (DefineSprite) according to the defined order.

For example, the procedure of adding the ith Flash file into the ith subsidiary animation clip comprises two steps:

Step a): update every CID value in the Flash file.

In a Flash file, the CID value of an object must be universally unique, therefore the CID values of all objects in the flash file to be combined should be updated. In practical applications, a universal CID distributor defines the CID values from 1 to N while the Swf prototype is created; when the ith Flash file is combined, all label blocks in the Flash file are checked and the objects with conflicting CID values are given new CID values by the CID distributor, then all corresponding CID values in the label blocks, e.g., the CID values in PlaceObject2 and RemoveObject2, shall also be modified.

Step b): combine:

Firstly, the definition label blocks and the control label blocks in the Flash file to be combined shall be identified. Then, all definition label blocks are placed before corresponding DefineSprite label block in the PrototypeSwf (before playing a frame in the Flash player, all objects in the display list must be defined before the ShowFrame label blocks, hence the definition label blocks in the Flash file have to be placed before corresponding DefineSprite label block). After that, all control label blocks are placed into the corresponding DefineSprite label block in the PrototypeSwf, i.e., into the subsidiary animation clips; the number of ShowFrame label blocks in the Flash file are then counted for the purpose of modifying the FramCount value in the corresponding DefineSprite label block in the PrototypeSwf. Since the control label blocks decides how to play the defined objects, the control label objects in the Flash file shall be set as the children label blocks under corresponding DefineSprite label block in the PrototypeSwf. In this way the Flash file is combined into a subsidiary animation clip.

Obviously, the above procedure is not used for limiting the method of combining a plurality of animation frames into one animation. For example, the combined animation may be compressed to one layer according to the requirements to the display effect and a plurality of files is combined into one integrated file accordingly. Other methods known to those skilled in the art may also be adopted for combining the animation frames.

In the preceding embodiments, the final visual effect of the overlapping video and animation is viewed at the receiving end or at both the transmitting and the receiving end of the video interaction. When the visual effect is viewed only at the receiving end, the steps of capturing the video images and the animation frames may be performed at the receiving end as well as the steps of configuring and overlaying (e.g., the transmitting end sends the video images and the animation frames to the receiving end, or the transmitting end sends the video images to the receiving end and the receiving end obtains animation frames from a server). When the visual effect shall be viewed at both the transmitting end and the receiving end, the transmitting end also performs these steps to capture the same images and frames and get the same display output.

The animation frames may be customized animation frames chosen by the user via a man-machine interface. The user may also configure the chosen animation frames, e.g., sets the playback time and transparency of the animation frames.

In practical applications, the order of performing the steps in the preceding embodiments is not limited to a certain order, e.g., the animation frames may be obtained before the video images are captured, and the animation frames and the video images may be combined before the animation attribute(s) is configured.

The above is only the preferred embodiments of the present invention and should not be used for limiting the protection scope of the present invention. All modifications and equivalent substitutions within the technical scope disclosed by the present invention, which are made by those skilled in the art without inventive steps, should be covered by the protection scope of the present invention.

What is claimed is:

1. A system for generating interactive video images, comprising a video image capture module, an animation capture module and an overlay module, wherein:
the video image capture module is adapted to capture video images and output the video images to the overlay module;
the animation capture module is adapted to obtain animation frames and output the animation frames to the overlay module; and
the overlay module is adapted to overlay the video images from the video image capture module with the animation frames from the animation capture module.

2. The system for generating interactive video images according to claim 1, wherein the video image capture module further comprises a format conversion sub-module and an animation generation sub-module;
the format conversion sub-module is adapted to convert the video images into pictures in a preset format and send the pictures in the preset format to the animation generation sub-module; and
the animation generation sub-module is adapted to convert the pictures in the preset format from the format conversion sub-module into animation frames.

3. The system for generating interactive video images according to claim 1, wherein the system further comprising an animation attribute configuration module;
the animation attribute configuration module is adapted to configure a transparency attribute of every pixel in the animation frames from the animation capture module and to send the animation frames with the configured transparency attribute to the overlay module.

4. The system for generating interactive video images according to claim 1, wherein the overlay module further comprises:
a display overlay module, adapted to overlay the display of the video images from the video image capture module with the display of the animation frames from the animation capture module.

5. The system for generating interactive video images according to claim 1, wherein the overlay module further comprises:
a overlay module, adapted to combine the animation frames from the animation capture module and the video images from the video image capture module into one file and save the one file.

6. The system for generating interactive video images according to claim 1, wherein the system further comprises a combine module adapted to combine a plurality of animation frames from the animation capture module into one animation frame and send the one animation frame to the overlay module.

7. The system for generating interactive video images according to claim 6, wherein the combine module further comprises a display layer allocation sub-module and a content allocation sub-module;
the display layer allocation sub-module is adapted to allocate different independent display layers to different animation frames to be combined; and
the content allocation sub-module is adapted to put contents of the animation frames into the display layers allocated to the animation frames respectively.

8. A method for generating interactive video images, comprising:
capturing video images;
obtaining animation frames; and
overlaying the video images with the animation frames.

9. The method for generating interactive video images according to claim 8, wherein the capturing video images further comprises:
converting the video images into pictures in a preset format; and
converting the pictures in the preset format into animation frames.

10. The method for generating interactive video images according to claim 8, after the obtaining the animation frames, further comprising:
configuring a transparency attribute of every pixel in the animation frames.

11. The method for generating interactive video images according to claim 8, wherein the overlaying the video images with the animation frames further comprises:
overlaying the display of video images with the display of the animation frames.

12. The method for generating interactive video images according to claim 8, wherein the overlaying the video images with the animation frames further comprises:
combining the animation frames and the video images into one file; and
saving the one file.

13. The method for generating interactive video images according to claim 8, wherein an animation frame is the combination of a plurality of animation frames.

14. The method for generating interactive video images according to claim 13, wherein the animation frame being the combination of a plurality of animation frames comprises:
allocating different independent display layers to different animation frames to be combined; and
putting contents of the animation frames into the display layers allocated to the animation frames respectively.
